(19) United States
(12) Patent Application Publication
(10) Pub. No.: US 2022/0319184 A1
(43) Pub. Date: Oct. 6, 2022

(54) SYSTEM FOR CHECKING AN OPERATING CONDITION OF A COMPONENT ON A VEHICLE AND METHOD FOR CHECKING AN OPERATING CONDITION

(71) Applicant: SAF-HOLLAND GmbH, Bessenbach (DE)

(72) Inventors: Mark Hartmann, Heigenbrucken (DE); Bernd Brunsch, Dreieich (DE); Mario Sebastian Köster, Bodman-Ludwigshafen (DE)

(21) Appl. No.: 17/805,305

(22) Filed: Jun. 3, 2022

Related U.S. Application Data
(63) Continuation-in-part of application No. PCT/EP2020/084126, filed on Dec. 1, 2020.

(30) Foreign Application Priority Data
Dec. 5, 2019 (DE) 10 2019 133 171.4

(51) Int. Cl. G06V 20/54; G06V 20/62; G07C 5/08

(52) U.S. Cl. CPC G06V 20/54; G06V 20/625; G07C 5/0841; G07C 5/0816

(57) ABSTRACT

A system for checking an operating state of a component on a vehicle, in particular on a commercial vehicle, comprising a detection device which detects information in the form of a data set, in particular an image data set, in a defined region on the vehicle, the defined region comprising the component to be checked, and an evaluation device to which the data set is provided, wherein the evaluation device is configured to determine the operating state of the component on the basis of the detected data set, wherein the detection device is arranged outside the vehicle.

### CROSS-REFERENCE TO RELATED APPLICATIONS

This application is a continuation-in-part of International Application No. PCT/EP2020/084126 filed on Dec. 1, 2020, which claims priority to German Patent Application No. DE 10 2019 133 171.4, filed in Germany on Dec. 5, 2019, which are incorporated herein by reference in their entireties.

### BACKGROUND OF THE INVENTION

The present invention relates to a system for checking an operating state of a component on a vehicle and a method for checking an operating state.

It is known from the prior art that certain components of a vehicle, in particular on an exterior of the vehicle, can assume different operating states. For example, the vehicle is a commercial vehicle, in particular a semitrailer tractor, in which locking devices, e.g. for locking doors or on a fifth wheel, are provided on a trailer, in particular a semitrailer, which should be closed in the driving state. Typically, a driver of the commercial vehicle or of the vehicle checks whether all locking devices are properly closed before starting or continuing the journey. Furthermore, the state of the art is familiar with devices that automatically or actively transmit signals or information that provide information about the current operating state, for example of a locking device.

It is also known from EP 1 088 286 B1 to provide roadside inspection devices with which number plates are recorded in order to use them for toll purposes.

It is therefore an object of the invention to determine the operating state of a component as it is intended for driving, wherein the determination is simplified and less time-consuming, in particular in comparison to the methods known from the prior art. Furthermore, it should also be possible for existing vehicles to use the corresponding system for checking an operating state.

### SUMMARY OF THE INVENTION

According to a first aspect of the present invention, a system for checking an operating state of a component on a vehicle, in particular on a commercial vehicle, is provided comprising a detection device (10) which detects information in the form of a data set, in particular an image data set, in a defined area on the vehicle, the defined area comprising the component to be checked, and an evaluation device to which the data set is provided, the evaluation device being configured to determine the operating state of the component on the basis of the detected data set, wherein the detection device is arranged outside the vehicle. In contrast to the systems for checking the operating state known from the prior art, namely visual detection by the user or by means of devices which transmit information directly from the vehicle to the driver, it is provided in accordance with the invention that the detection device is designed or arranged outside the vehicle. In particular, the detection device is aligned or designed in such a way that a vehicle driving past the detection device is detected by the detection device in order to record a data set, which is in turn forwarded to the evaluation device in order to evaluate the passively recorded data set accordingly. For this purpose, the evaluation device comprises, for example, a microprocessor which is designed, in particular programmed or configured, to determine the operating state of the respective component on the basis of the recorded data set. For example, the component is a loading surface of a tipper truck, in which it is determined whether a tippable surface is tilted or—as is desired for the driving state—is aligned essentially parallel to the roadway. It is also conceivable that the operating state of a lift axle is determined, i.e. an axle that can be lifted when the vehicle is under low load. Here the lift axle is the component to be checked. The detection device is preferably a camera which takes one or more images of a defined area, in particular a partial section of the exterior view of the vehicle. It would also be conceivable to have detection devices that record light of other wavelengths or other spectral ranges, such as infrared cameras, for detecting the component. For example, the camera captures images in a visible and infrared spectral region. For example, in brakes, especially disc brakes, the temperature can be determined using infrared optics. For this purpose, for example, an infrared image of the brake disc can be recorded with a camera when a wheel axle passes a trigger, in order to detect possibly deviating temperatures of the individual brakes of the vehicle or the exceeding of a defined temperature value. Furthermore, it is conceivable that the detection device and/or the evaluation device is configured to cut out a partial area from a recorded image data set, which is in turn used for evaluation by means of the evaluation device to determine the operating state. The parts of the image data set that cannot provide information on the operating state that is to be checked can be removed. It is also conceivable that the image data sets are subjected to a preparatory step before evaluation. For example, in such a preparatory step, the image data sets are transformed to a common coordinate system in order to take into account that the respective vehicles may pass the detection device at different angles to it. Accordingly, possible distortions in the recording of the image data set can already be compensated for in this preparatory step. Furthermore, it is preferably provided that the evaluation device is centralized or is part of a network. For example, it is intended that several detection devices share an evaluation device which is provided on a server of a network. For example, the evaluation device is part of a network in which several servers are interconnected in order to identify the operating state. Furthermore, it is particularly preferred that the evaluation device is configured to identify the type of the respective component. In an identification step preceding the test step of the operating state, it is therefore intended to first identify the type of the detected component. This makes it possible to take into account any differences in the respective types of the individual components. For example, the position of a safety lever for an unlocking lever on a fifth wheel changes from type to type, so that only the type designation of the respective fifth wheel can be used to determine whether the fifth wheel is in an open or partially open or locked or unlocked state. A commercial vehicle trailer or commercial vehicle is in particular a trailer which has a permissible total mass of at least 7.51 t, preferably of at least 10.1 t and particularly preferably of at least 15.1 t.

Furthermore, it is particularly preferred that the detection device detects a solid angle of at least 90°, preferably at least 120° and especially preferably at least 150°. In particular, it is intended that the detection device is designed or arranged in such a way that, if possible, an entire side surface of a vehicle is detected. In this way, it is advantageously possible to use certain boundaries or edges of the side surface of the vehicle as a reference, in particular in order to use these accordingly in the case of possible corrections with regard to the distortion. Preferably, the detection device is arranged on one side relative to the roadway along which the vehicles to be monitored are travelling, in order to record a side view and/or a rear view of the vehicle. Preferably, the detection device records two data sets with a time delay, one from the side view and one from the rear view. It is also conceivable that several detection devices are placed on the road in order to monitor both side views of the vehicle, for example. Optionally, detection devices can also be embedded in the roadway in front of and behind a sensor area in order to create an all-round image of the vehicle, for example. For example, changes to the bodywork and/or light carriers, such as damage, can be detected by comparing them with a target profile of the vehicle, i.e. with regard to the length, width and/or height of the vehicle or articulated lorry. Using infrared cameras, damage to the insulation of a refrigerated box and/or an open hatch, for example, can also be detected, as the infrared image at this point would deviate from the rest of the flank of the vehicle.

Furthermore, it is conceivable that the detection device is arranged at the height of the component to be monitored or detected in order to record an image that is as distortion-free as possible.

According to a preferred embodiment, it is provided that the component comprises a locking device. This makes it advantageous to check the locking state, for example of a hatch and/or door on the fifth wheel trailer, on a fifth wheel or of fastening straps and tensioning belts. It is particularly advantageous if it can be determined by means of the device for checking the operating state whether the vehicle has been properly locked or closed. For example, the detection device captures at least a section of an image that represents the locking device and, on the basis of the captured image, the evaluation device detects whether the locking state is present or whether, for example, the rear door or tarpaulin of the trailer is not properly locked or closed.

Preferably, the component is at least partially modified. In particular, the component is modified in such a way that it is more easily identified by the detection device and/or the evaluation device than the non-modified component. The modification of the component may be provided by an indicator element or area, for example with a color marking, with reflectors and/or with LEDs. For example, the locking device is polished and/or provided with a sticker that facilitates identification. In contrast to costly upgrading measures, in such cases it is only necessary, for example, for a sticker to be provided in a certain color or with a certain code, in particular QR codes and/or bar codes, and the type and/or the position of the respective sticker is detected by means of the detection device or the evaluation device on the basis of the identified color code or bar code. It is also conceivable that a corresponding identification is engraved or painted onto the component elements.

In particular, it is envisaged that the component is or will be at least partially modified to form an indicator area. Preferably, it is conceivable that the indicator area is retrofitted by subsequently attaching it to the component. In particular, it is envisaged that the detection orientation is designed to search a vehicle for and/or locate the indicator area. For example, it is conceivable that the evaluation device determines the operating state of the component on the basis of the position of the indicator area in relation to an outer contour of the component or of the vehicle. It is also conceivable that several indicator areas are provided and that the orientation of the component is determined on the basis of at least two indicator areas. For example, one indicator area is arranged on the component and another indicator area is arranged as a reference on another vehicle component which is not the component.

It is preferably provided that the indicator area is formed on a visible side or outside of the component in order to be able to be detected visually. Preferably, the indicator area itself does not contain any information, but its position or orientation relative to a reference provides information about the operating state.

Preferably, the component is a latch.

It is also conceivable that the indicator area is a sticker. For example, it is conceivable that similar stickers are distributed over the vehicle on various components and the detection device searches for the stickers and locates them. It is also conceivable that the detection device prioritizes indicator areas, i.e. the detection device only detects image data sets of further components when the prioritized components have been detected and evaluated.

Furthermore, it is conceivable that the detection device sends the detected image data sets to the evaluation device in real time and detects further image data sets. In other words, it does not wait until all image data sets have been captured to start evaluating the image data sets. This saves time and the driver of the vehicle can be informed as quickly as possible.

According to a further embodiment, it is intended that the detection device is stationary. For example, the detection device is embedded in a column at an automated logistics yard, a service station or a petrol station, or is arranged in a transverse beam above the roadway, such as an archway at the exit of a car yard or fleet, in particular to form a sensor bridge. In particular, it is a system of several detection devices. In particular, the commercial vehicle forcibly passes such a sensor bridge or “gate”. It is also conceivable that the detection device is embedded in the ground over which the vehicle is guided.

Preferably, such a detection device is coupled, for example, to a barrier system that a vehicle must pass in order to leave the vehicle park or car yard. Accordingly, the short-term standing or standing time in front of the barrier can advantageously be used to record the data set. For this purpose, it is advantageously provided that the detection device is coupled with the function of the barrier system. For example, the detection is started by the detection device when the barrier system detects that a vehicle stops in front of the barrier system.

Preferably, the detection device is placed at positions where vehicles have to stop, for example at barriers and/or traffic lights. This gives the detection device sufficient time to determine sufficient image data sets.

Advantageously, the evaluation device is configured to determine the operating state of the component independently of type on the basis of the locking state.

According to an alternative embodiment, the detection device can also be mobile and, for example, placed on a mobile or flying drone. This enables, for example, flexible all-round shots of the vehicle and facilitates the detection of components that would otherwise be difficult to see.

Preferably, the system includes a communication device. For example, the user of the vehicle is informed by means of the communication device that there is an operating condition that is unsuitable for the driving condition. For this purpose, the communication device communicates with an on-board computer in a vehicle, for example. It is also conceivable that the detection device detects the registration number of the vehicle, or a marking that identifies the owner of the commercial vehicle, and the driver or the owner of the vehicle is informed of the fault by means of a message, for example a text message, for example by contacting a corresponding mobile telephone whose telephone number is stored together with the registration number for the vehicle. Alternatively or additionally, it is conceivable that the detection device and/or the barrier system is designed to emit a warning signal, in particular an acoustic or visual warning signal, if an operating state has been detected that is not intended for the driving state.

Preferably, the evaluation device is connected to a network. In particular, the evaluation device accesses corresponding databases in the network for the identification and/or determination of the operating state. For example, the vehicle can be recognized, identified and assigned relatively easily by recording a number plate or registration number. If the registration number is captured, the vehicle can be recognized, identified and assigned relatively easily. If the vehicle has already passed the detection device, it is possible to register changes to the bodywork, e.g. damage, and to send an automatic maintenance message to maintenance personnel. For this purpose, for example, software, which is provided in particular for evaluating the data set from the detection device, synchronizes with external software, preferably in order to include images from other vehicles in the evaluation, which have not yet passed the detection device. For example, the evaluation device performs a simple comparison between the image data set recorded by the detection device and the image information about the passing vehicle from the external software or database (before/after comparison).

In this way, the evaluation device can benefit in an advantageous way from the information on the operating states stored in the network. For example, changes to the bodywork or light carriers, such as damage, can be detected by comparing them with a target profile of the vehicle, which can be obtained via the network.

It is particularly preferred that the evaluation device determines the operating state and/or the defined area for the detection of the data set by means of machine learning, in particular by means of neural networks. For this purpose, it is particularly intended that the evaluation device is trained with corresponding training data sets so that the evaluation device learns as independently as possible to determine and identify the operating state. For example, a “deep-learning” algorithm is used for this.

It is preferably provided that the data set, in particular the image data set, records a temporal development or comprises a temporal sequence of images. Within the framework of a preparatory work step, it is then envisaged that the detection device and/or evaluation device carries out a preliminary evaluation of the detected image data sets and, for example, excludes from further evaluation those parts of the image data set or the image data sets which do not fulfil certain criteria with regard to resolution and/or contrast. Furthermore, it is conceivable that the detection device only takes into account those image data sets in which the recorded component whose operating state is to be recorded is represented as large and detailed as possible. Accordingly, the evaluation of the best image data set, in particular the image, is carried out by means of a suitable preselection of the image data set.

For example, it is conceivable that by means of a light barrier or a motion sensor, the detection device is transferred from a rest state to a detection state by the detection device recording corresponding data sets over a fixed time interval. This reduces the energy consumption of those detection devices that are rarely passed by a vehicle.

Preferably, the detection device is configured to automatically determine the detection of the image data set. For example, the detection device recognizes certain reference points on the vehicle in order to use these corresponding reference points to trigger the detection device. This makes it possible, for example, for the capture device to capture and preferably store a rear view of the vehicle only after the vehicle has already passed the capture device. This reduces the number of recordings of the data set to a minimum, wherein unnecessarily recorded data sets are not generated or stored in the first place. This proves to be advantageous for the service life of the detection device and reduces the amount of data sets to be communicated in a beneficial manner.

It is preferably provided that the detection device detects further information, in particular further information individually assigned to the vehicle, wherein the further information can preferably be stored or is stored in a storage device together with the locking state or the determined operating state. In this way, it can be advantageously documented that a specific vehicle passed the detection device at a specific time in a specific operating state at a specific location.

According to a further preferred embodiment, it is provided that the evaluation device is configured to identify and preferably classify components. Also, several (different) component components can be detected by the detected data set, which are checked for an operating state. For example, the detection device simultaneously detects several components, each of which is checked with regard to its operating state. In this way, it can be determined simultaneously whether all operating states are in a state that permits driving operation.

In a preferred embodiment, the detection device is arranged at the height of the component to be monitored or detected.

In another preferred embodiment, the vehicle always passes the detection device, in particular the optical detection device, at a predefined distance and angle in order to ensure the reliability of the measurements. In this case, it is intended that the detection device is integrated into a device, for example a sensor bridge and/or a barrier area, which forces the vehicle to pass the detection device within a predefined range. Furthermore, if a distance between a loading edge and a roadway on which the vehicle is moving is less than on arrival or less than a minimum distance at the same distance from the detection device, an overloaded condition can be easily identified in an advantageous manner. Preferably, an additional detection device is used to record a comparison data set, which is preferably compared with the data set recorded by the detection device in order to record a change between the recording of the comparison data set and the data set. For this purpose, for example, the additional detection device is embedded in an entrance area to a logistics yard, a service station and/or a petrol station, while the detection device is embedded at the exit of the logistics yard, the service station and/or the petrol station.

Furthermore, the rear of the vehicle, in particular of the semi-trailer, is preferably held or detected by the detection device. In an alternative or supplementary embodiment, a side view of the trailer or the vehicle is recorded. Such a side view makes it possible, for example, to detect a safety lever on a fifth wheel in order to determine whether the safety lever secures or unlocks the unlocking lever. In addition, the side view can be used, for example, to compare a loading state with a loading list. The distance between a loading edge and the road can be used to detect an overloaded condition. Optionally, the weight can also be measured with a scale and assigned to a specific vehicle by comparing it with the recorded registration number.

A further object of the present invention is a method for determining an operating state of a component of a vehicle, in particular of a commercial vehicle, having a system for checking an operating state of a component on a vehicle, in particular on a commercial vehicle, comprising the steps of (a) detecting information in the form of a data set, the information being present in a defined area on the vehicle, and (b) providing the data set to an evaluation device, and (c) determining the operating state of the component on the basis of the detected data set by the evaluation device, wherein the detection device is arranged outside the vehicle. All the advantages and features described for the system can be transferred analogously to the method and vice versa.

### BRIEF DESCRIPTION OF THE DRAWINGS

Further advantages and features result from the following description of preferred embodiments of the object according to the invention with reference to the attached figures. It shows:

FIG. 1 is a system for checking a component of a vehicle according to a preferred embodiment of the present invention;

FIG. 2 is a fifth wheel suitable for a method of checking a component according to a first exemplary embodiment of the present invention;

FIG. 3 is a rear view of a trailer suitable for a method for checking a component according to a second exemplary embodiment of the present invention;

FIGS. 4a and 4b are a rear view and a side view of a trailer suitable for a method for checking a component according to a third exemplary embodiment of the present invention;

FIG. 5a is a tire on an control surface suitable for a method of checking a component according to a fourth exemplary embodiment of the present invention by means of an optical detection device;

FIG. 5b is a tire on a control surface suitable for a procedure for checking a component according to a fifth exemplary embodiment of the present invention by means of distance sensors;

FIG. 6 is a system for checking a component of a vehicle according to a sixth embodiment of the present invention in side view (top) and bird's eye view (bottom); and

FIG. 7 s system for checking a component of a vehicle according to a seventh embodiment of the present invention in side view (top) and bird's eye view (bottom).

### DETAILED DESCRIPTION OF THE PREFERRED EMBODIMENTS

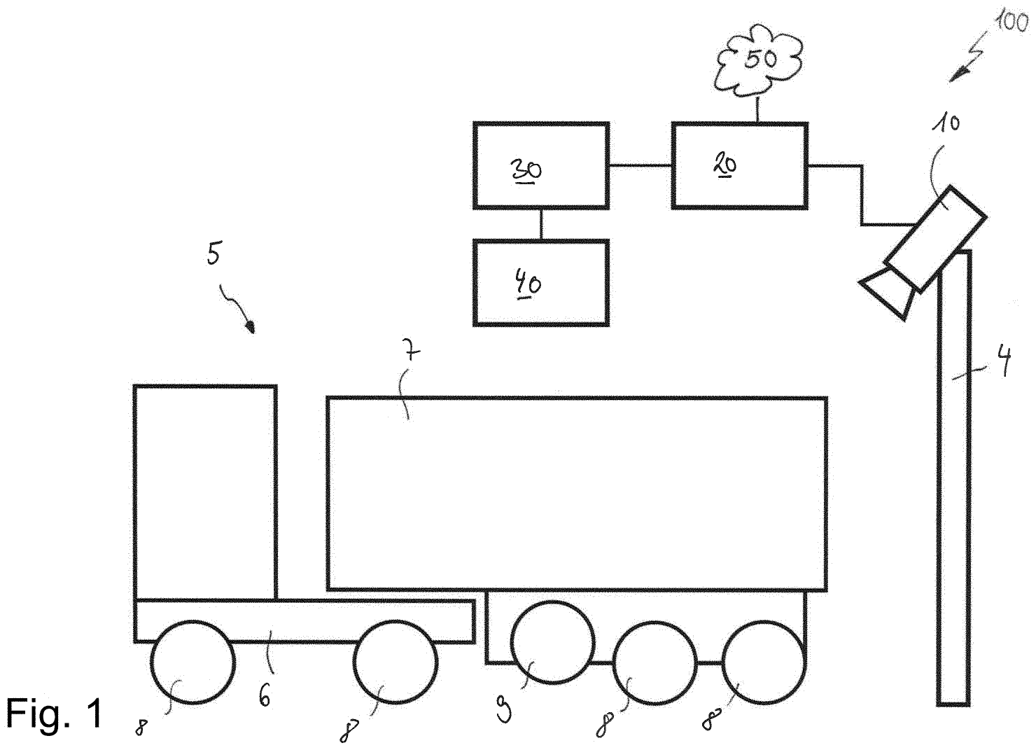

FIG. 1 shows a system 100 for checking an operating state of a component on a vehicle 5 according to a first preferred embodiment of the present invention. In the example shown, the vehicle 5 is an articulated vehicle with a tractor unit 6 and a semi-trailer 7. Such a vehicle 5 comprises several components which can be in different operating states. An example of such a component is a lift axle 9, which is, for example, part of a semi-trailer 7 and differs from the other axles 8 of the semi-trailer in that the lift axle 9 can be raised when the load is low in order to minimize its wear. This proves to be particularly advantageous when the load condition does not require all axles 8, i.e. in particular the lift axle 9, to contact the ground. A further component is, for example, a locking system with which a loading area of the semi-trailer 7 can be closed. With the system for checking an operating state, it is intended to check the operating state of the respective components on the vehicle 5 even when the vehicle 5 has already started travelling, i.e. not only during a preparation phase or during a stationary period. For example, it can still be determined that inadvertently assumed, in particular unwanted, operating states are maintained during a driving state of the vehicle 5. An essential component of such a system is a detection device 10, which preferably records information in the form of a data set in a defined area on the vehicle 5, the defined area in particular comprising the component. For example, the detection device 10 is at least one camera which detects one image or several images in the form of an image sequence from the vehicle 5, in particular from the component whose operating state is to be checked. For example, such a detection device 10 is mounted on an archway 4 through which a truck or vehicle 5 must pass when leaving a yard or defined area. In particular, the detection device 10 is arranged centrally in the roadway or towards the roadway. This makes it possible to avoid or minimize any distortions when recording the image data set. It is also conceivable to place the detection device 10 at the side of the roadway in order to also capture a side view of the vehicle 5. Furthermore, it is conceivable that, for example, the detection device 10 can be transferred between a detection state and a rest state. Preferably, further sensors are provided, such as motion sensors and/or light barriers, which detect the presence of a vehicle 5 in order to transfer the detection device 10 from a rest state to a detection state. It is also conceivable that a barrier is coupled to the detection device 10 so that the detection device 10 is in a detection state or a rest state depending on the state of the barrier, wherein the detection device 10 can advantageously be regularly transferred to a rest state in order to save energy. Preferably, the detection device 10 is arranged above 3 meters above the road surface. Accordingly, the detection device 10 can record image data sets of the vehicle 5 from above. In addition to the detection device 10, the system preferably comprises an evaluation device 20 to which the data set is provided. For example, the data set is provided via a wire connection or a wireless connection, for example via Bluetooth or WLAN. The data set detected by the evaluation device 20 is then evaluated. For this purpose, the evaluation device 20 is configured in such a way that it can determine the operating state of the component on the basis of the detected data set from the vehicle 5. In particular, the evaluation device 20 compares the determined operating state in the data set with stored or deposited information on the respective component. Accordingly, the evaluation device 20 is configured to identify the respective component and preferably to assign it to a corresponding type. After the identification step, it is determined whether the identified component is in an operating state that is usual for the driving state or for a stationary state of the vehicle. For this purpose, the evaluation device 20 preferably accesses a database and/or a network 50, on the basis of which the evaluation device 20 can determine the operating state. Particularly preferably, the evaluation device 20 uses a neural network, in particular a machine learning process, to identify the component and/or to identify its operating state. For this purpose, the evaluation device 20 is particularly preferably trained with corresponding data sets which it contains either from the detection device 10 and/or the network 50. By means of these training data sets, it is possible to optimize the wealth of experience of the evaluation device 20 to the effect that the operating state can be identified as error-free as possible. Preferably, the determined operating state is stored in a storage device 30, for example together with further information about the vehicle 5, which is particularly preferably individual. For example, the evaluated operating state is stored together with a number plate or a registration number on the vehicle. It is further preferred that the system comprises a communication device 40. This communication device 40 preferably automatically contacts the vehicle if, for example, an operating state has been identified on the vehicle 5 which is not intended for the driving state. For example, the communication device 40 transmits a corresponding error message to an on-board computer of a vehicle 5, in particular to a tractor unit 6 of the articulated vehicle. Accordingly, the driver is informed in good time and in particular in a timely manner about the presence of a possible fault condition. Furthermore, it is conceivable that the communication device 40 communicates with a corresponding barrier system or a corresponding barrier, so that the vehicle 5 is only allowed to continue its journey when clearance has been given by the communication device 40. Accordingly, the risk is minimized that a vehicle 5 continues or starts driving despite an operating state that is not intended for the driving state. In addition or alternatively, it is conceivable that an acoustic and/or optical warning message is emitted when an operating state that is not intended for driving is detected. For example, a corresponding device is provided for emitting the warning signal at the detection device 10 and/or at the archway 4 in order to inform the user or the driver of the vehicle 5 about the fault condition.

An example of an operating state not intended for the driving state would be, for example, an open locking device 22. However, it is also conceivable that the operating state checked is the state of the lift axle 9. Thus it is possible to determine by means of the detection device 10 and the evaluation device 20 whether the lift axle 9 is in the raised state, in which it is at a distance from the roadway, or in a lowered state, in which the lift axle 9 is in contact with the ground. It is further conceivable that, in addition to the detection device 10, a further sensor device is provided which, for example, detects the weight of the saddle train in order to determine, as a function of the weight, whether it is appropriate for the lift axle 9 to be in a raised state or a lowered state. Accordingly, this further information may be used to determine whether an operating condition impedes continued travel or is consistent with the intended operation of the vehicle. In addition to the lift axle 9 or the locking state of the vehicle 5, it is conceivable to use the detection device 10 to determine, for example, the tipping state of a tipping vehicle, i.e. a vehicle with a tipping loading surface. For example, it is possible to determine whether the loading surface of the vehicle 5 is tilted or runs essentially parallel to the roadway.

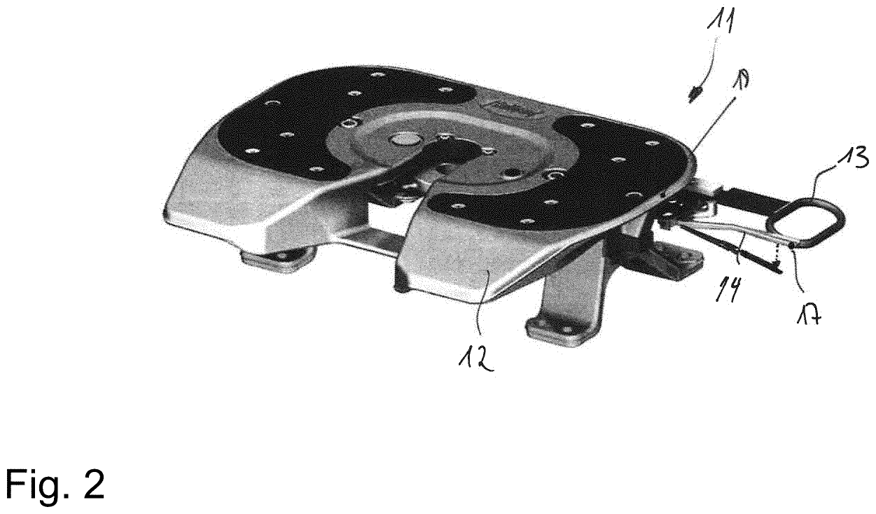

FIG. 2 shows a fifth wheel 11 suitable for a method of checking a component according to a first exemplary embodiment of the present invention. In the example shown, it is a fifth wheel 11 with a coupling plate 12, via which a connection is typically made between the tractor unit 6 and the semi-trailer 7. In order to fix a king pin of the semitrailer to the tractor unit, this king pin is inserted into a slot-like opening of the coupling plate 12 and fixed by means of a unlocking lever 13, in particular by means of an automatic lock with a unlocking lever. In addition to the unlocking lever 13, a safety lever 14 is also provided, which prevents the unlocking lever 13 from being moved inadvertently and the king pin from being released. By means of the detection device 10, it is possible to determine the respective orientation of the safety lever 14, in particular the safety lever 14 is tilted about an axis running substantially parallel to the roadway when it is transferred to a state in which the unlocking lever 13 can be actuated. By means of the detection direction 10 it is then advantageously possible, together with the evaluation device 20, to determine in which state the safety lever 14 is. If the safety lever 14 is in a lowered state, the unlocking lever 13 is unlocked. This state is not intended for driving, so that if the evaluation device 20 detects it, a message can be transmitted to the vehicle, for example.

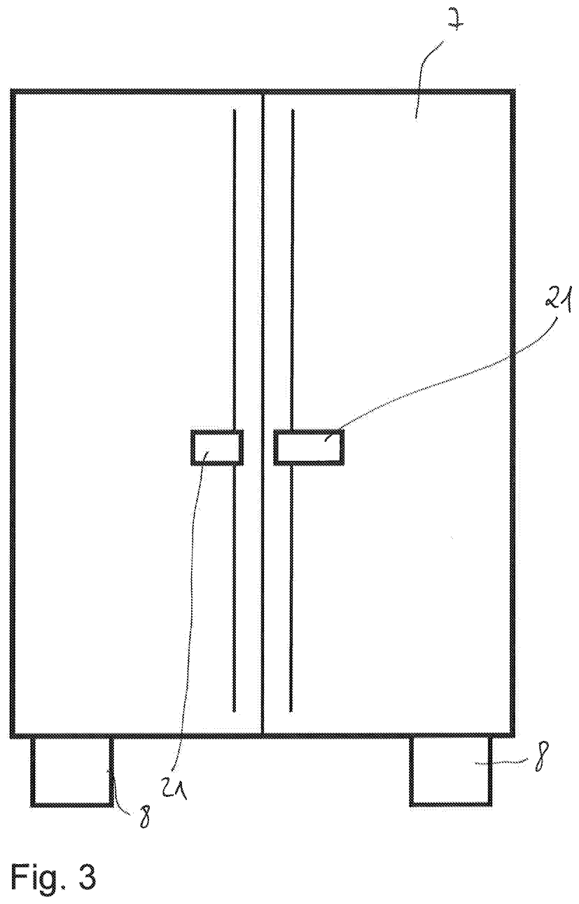

FIG. 3 shows a rear view of the semi-trailer 7. Such a view can be used, for example, for the method for checking a component according to a second exemplary embodiment of the present invention. In the image shown, which is recorded for example by the detection device 10, a locking device 21 can be seen on the rear of a semi-trailer 7, with which doors which release or close the load compartment can be locked. In particular, it is intended that the right-hand locking device is closed, while the left-hand locking device is open. By means of the detection device 10, it is then advantageously possible, together with the evaluation device 20, to determine that the left-hand locking device is open.

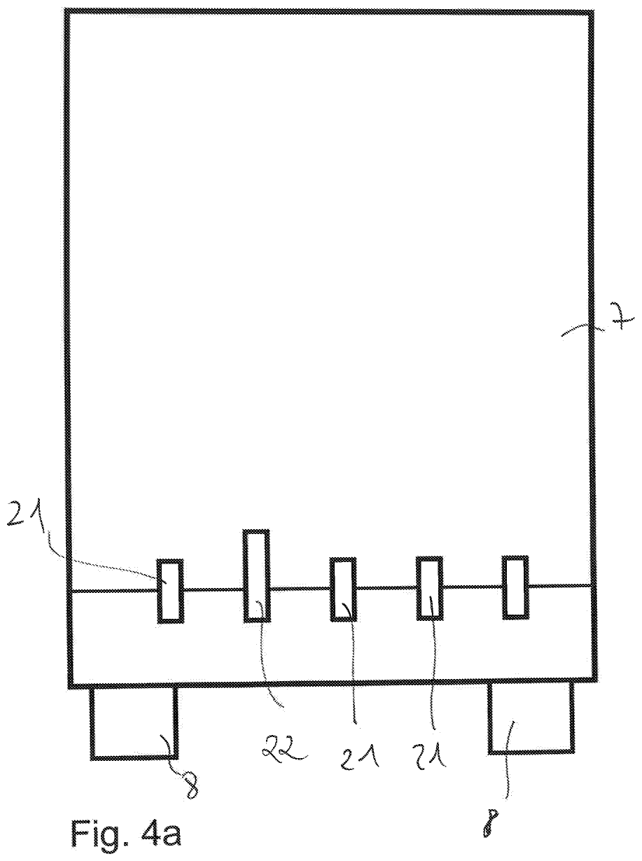

FIG. 4a shows a rear view and FIG. 4b a side view of another semi-trailer 7 suitable for a method for checking a component according to a third exemplary embodiment of the present invention. The semi-trailer 7 shown here is a loading volume which is closed by means of a tarpaulin. On an underside, i.e. at an end of the tarpaulin facing the vehicle frame, corresponding loop-like and/or eyelet-like devices are provided here, with which the tarpaulin can be attached to the vehicle frame. By means of the detection device 10 and the evaluation device 20, it is advantageously possible to determine those locking devices, consisting of an eyelet and a loop, which are open or closed. This makes it advantageously possible to determine whether one of the said systems for closing or tying the tarpaulin to the vehicle body is open or not. For example, it is conceivable that the evaluation device 20 instructs the communication device 40 to transmit information to the driver of the vehicle 5 if a plurality or a defined number of loops and eyelets are not closed, so that the driver is only informed of the faulty state of the locking device when there is a certain safety risk. Accordingly, the driver is not informed if only a single locking device is not closed, provided that this unlocked locking device does not endanger the driving operation.

Furthermore, it is advantageously provided that the entire side and rear view of the vehicle is preferably recorded with the detection device. This makes it advantageously possible to determine the extent of a distortion in relation to reference points, for example an upper edge of the trailer. Accordingly, the corresponding distortion can be taken into account during image processing or evaluation by transforming the image data accordingly. In this way, for example, after the transformation, the detected area, which is assigned to a specific locking device, can be used to determine whether a locking state or an open state is present at the locking device.

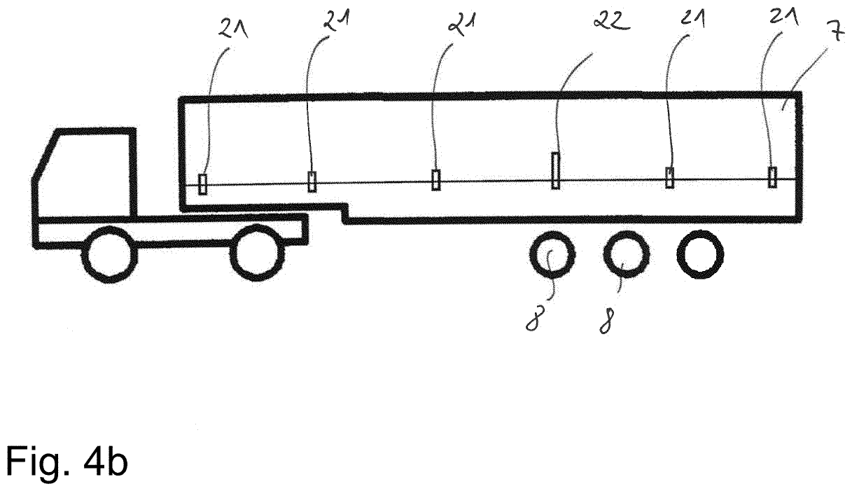

FIG. 5a shows a tire 104 of a vehicle 5 is shown on a control surface 105, in which, for example, a detection device 10 is embedded, suitable for a method for checking a component according to a fourth exemplary embodiment of the present invention. In the example shown, the detection device 10 is at least one optical sensor which is embedded in the roadway 101. When driving over the control surface 105 under which the optical sensor is located, image data of the tire profile 106 can thus be recorded and, for example, compared with a target profile. For example, if a worn tire profile 106 is detected, a message can be sent to the driver or to a vehicle control centre to arrange for a tire change. Since such a measurement can be carried out in passing, this method represents an advantageous time- and personnel-saving alternative to a manual measurement.

FIG. 5b shows a tire 104 of a vehicle 5, in particular a trailer 7, on a control surface 105 suitable for a method for checking a component according to a fifth exemplary embodiment of the present invention. In this example, the detection device 10 comprises distance sensors, such as ultrasonic sensors, and/or at least one ultrasonic sensor, which can preferably determine the tread surfaces and the specific depth of the tire profile 106 fully automatically. In this way, for example, tread grooves can be determined and compared with reference values.

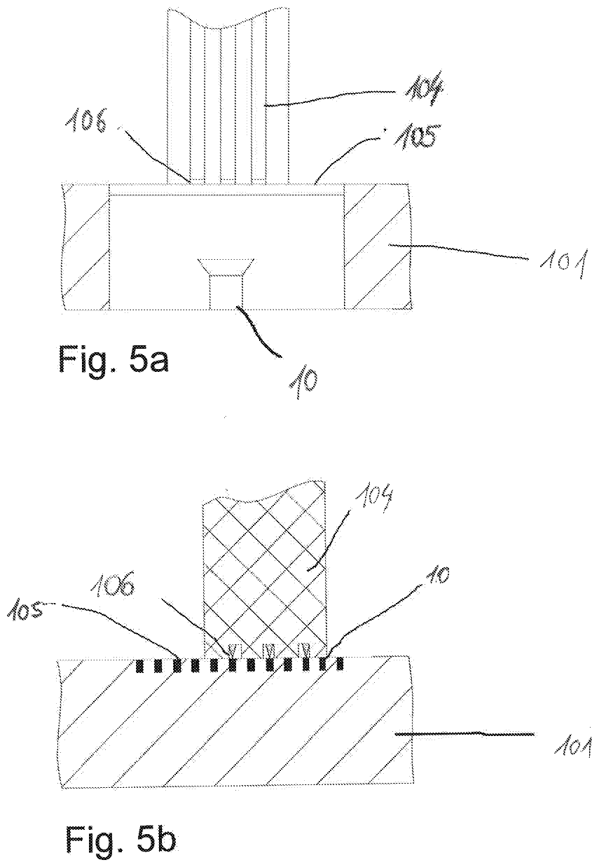

FIG. 6 shows a side view (top) and bird's eye view (bottom) of a system 100 for checking one or more components of a vehicle 5 with a length L, a height H and a width B according to a sixth embodiment of the present invention. In this example, the detection device 10 comprises several cameras which are mounted on the side or above the vehicle 5 and in front of and behind a sensor area 110 in the roadway 101 respectively. The sensor area 110 designates the area that can be detected by the detection device 10. The configuration shown here enables an all-round image of the vehicle 5 to be created and, for example, to be compared with a target profile of the vehicle 5, in particular of the trailer 7. In this way, for example, damage to a body of the vehicle 5, such as to sills or to light beams, can be registered. The detection device 10 in a cross member above the roadway 101, as is conceivable in particular for petrol stations and/or service stations, could, for example, detect snow and/or ice deposits on the upper side of the articulated lorry and emit a warning message, for example, in order to reduce the danger for the following traffic.

The detection device 10 can optionally comprise infrared optics. This enables a temperature to be detected, for example, on brakes, in particular on disc brakes, of the vehicle, for example by producing an infrared image of a brake, in particular a disc brake, whenever an axle of the vehicle 5 passes a trigger. If the temperatures of the individual brakes of a vehicle 5 deviate from each other and/or if a brake exceeds a defined temperature value, an alarm can be issued, for example, to request maintenance.

Optionally, such an all-round monitoring system can also be used to check loading and ventilation hatches as well as locking systems 21 on the entire vehicle. For example, image data sets recorded by the detection device 10 can be compared with a target profile and thus, for example, open hatches, doors or loose fastening straps and tensioning belts can be detected. Alternatively or additionally, damage to the insulation of a refrigerated box can also be detected by the detection device 10 comprising infrared cameras. Open hatches as well as damage to the insulation could be detected by deviations of the temperatures detected in an infrared image from the remaining flank of the vehicle 5.

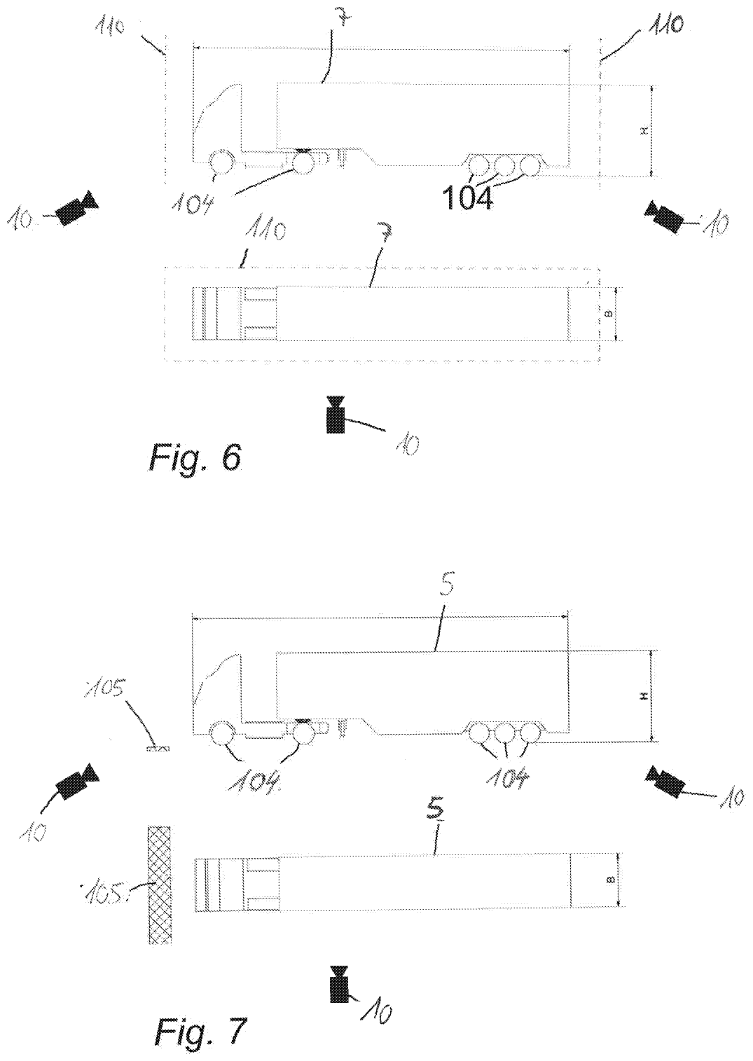

FIG. 7 shows a system 100 for checking one or more components of a vehicle 5 according to a seventh embodiment of the present invention in a side view (top) and a bird's eye view (bottom). Compared to the sixth embodiment described above, a control surface 105 located on the roadway 101 is added here, which includes a detection device 10 for measuring a tire profile 106, as shown in FIGS. 5a and 5b, respectively. This detection device 10 may include, for example, an optical camera and/or distance sensors. Alternatively or additionally, the control surface 105 may also contain a scale that can determine the axle load of the vehicle 5, for example.

### REFERENCE LIST

4 archway
5 vehicle
6 tractor unit
7 semi-trailer
8 axle
9 lift axle
10 detection device
11 fifth wheel
12 coupling plate
13 unlocking lever
14 safety lever
17 primary point
18 secondary point
20 evaluation device
21 closed locking device
22 open locking device
30 storage device
40 communication device
50 network
100 system
101 roadway
104 tire
105 control surface
106 tire tread
110 sensor area
B width of the vehicle
H height of the vehicle
L length of the vehicle

1. A system configured to check an operating state of a component on a commercial vehicle, comprising:
a detection device configured to detect information in the form of an image data set in a defined region on the vehicle, the defined region comprising the component to be checked; and
an evaluation device to which the image data set is provided, the evaluation device configured to determine the operating state of the component on the basis of the detected image data set;
wherein the detection device is arranged outside the vehicle; and
wherein the component is at least partially modified by a color marking, and wherein the component is a fifth wheel.

2. The system according to claim 1, wherein the component comprises a locking device.

3. The system according to claim 1, wherein the component is modified by the color marking, with reflectors by polishing, with a sticker, a marking engraved into or painted onto the components and/or with at least one LED.

4. The system according to claim 3, wherein the sticker is provided in a specific color or with a specific code, and wherein the detection device and/or the evaluation device is configured to detect the type of sticker and/or the position of the sticker.

5. The system according to claim 4, wherein the sticker includes a QR code and/or a bar code.

6. The system according to claim 1, wherein the detection device is stationary.

7. The system according to claim 1, further comprising:
a communication device configured to transmit information relating to the operating state to the vehicle.

8. The system according to claim 1, wherein the evaluation device is connected to a network.

9. The system according to claim 1, wherein the system is configured to detect changes to the bodywork or to light carriers by matching with a target profile of the vehicle, and wherein the target profile can be referred to via a network.

10. The system according to claim 1, wherein the evaluation device is configured to determine via machine the operating state and/or the defined area for the detection of the image data set.

11. The system according to claim 1, wherein the image data set comprises a temporal sequence of images.

12. The system according to claim 1, wherein the detection device is configured to automatically determine the detection of the image data set.

13. The system according to claim 1, wherein the detection device in configured to detect further information individually assigned to the vehicle, and wherein the further information can be stored in a storage device together with the detected operating state.

14. The system according to claim 1, wherein the evaluation device is configured to identify and classify components.

15. The system according to claim 1, wherein the system comprises a barrier in communication with the detection device and/or the evaluation device.

16. A method for determining an operating state of a component of a commercial vehicle having a system for checking an operating state of a component on the commercial vehicle, the component being at least partially modified by an indicator element or area, the modification of the component by an indicator element or area being provided with a color marking, comprising:
detecting information in the form of an image data set via a detection device, the information being present in a defined area on the vehicle, the defined area comprising the component to be checked;
providing the image data set to an evaluation device; and
determining the operating state of the component via the detected image data set by the evaluation device;
wherein the detection device is arranged outside the vehicle; and
wherein the component is a fifth wheel.

17. The method according to claim 16, wherein the color marking includes reflectors and/or at least one LED.

18. The method according to claim 16, wherein the color marking includes a sticker, and/or a marking engraved into or painted onto the component.
